(19) United States
(12) Patent Application Publication
(10) Pub. No.: US 2010/0180464 A1
(43) Pub. Date: Jul. 22, 2010

(54) Cores and microcapsules suitable for parenteral administration as well as process for their manufacture

(75) Inventors: Timo Laakso, Malmo (SE); Monica Joennson, Bara (SE)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6731, US

(73) Assignee: STRATOSPHERE PHARMA AB, Malmo (SE)

(21) Appl. No.: 12/596,180

(22) PCT Filed: Apr. 18, 2008
(86) PCT No.: PCT/EP08/54727

§ 371 Date: Mar. 9, 2010

(30) Foreign Application Priority Data
Apr. 19, 2007 (GB) 0707612.8

(51) Int. Cl. F26B 5/06

(52) U.S. Cl. 34/287

(57) ABSTRACT

The present invention relates to novel processes for the manufacture of cores of a specific polymer and a biologically active substance, and of such cores carrying a shell, i.e. microcapsules, to the cores and microcapsules thus produced, and to a pharmaceutical composition comprising such microcapsules.

### TECHNICAL FIELD

The present invention lies within the field of galenic formulations for the administration of biologically active substances (BASs hereinafter), more precisely cores for rapid release of BASs and microcapsules for controlled release of said BASs. More specifically, the invention relates to production processes for such cores and microcapsules containing said BASs and to the cores and microcapsules thus obtained.

### BACKGROUND OF THE INVENTION

There is a great need for rapid and controlled release formulations for BASs such as proteins, peptides and other drugs, especially for those that are administered parenterally. Despite many published approaches, there is no entirely satisfactory technology.

A process for manufacturing particles having a high dry content and a minimum binder content is known (WO0119345A1, WO02072070A1). Only non-parenteral compositions have been manufactured using pressurised air for atomisation, mechanical stirring of the cold fluid and drying by vacuum freeze drying.

A process for manufacturing sustained release microcapsules from a water-insoluble polymer dissolved in an organic solvent that utilises removal of the polymer solvent by extraction and needs a two zone process vessel one for freezing and one for extraction with an encircling flow of a liquefied gas in the former zone is known (U.S. Pat. No. 6,726,860 B2). This process is complicated and does not disclose the simplified and improved process and process design and cores or microcapsules of the present invention.

A process to manufacture particles by spraying into liquid nitrogen, utilising very high spray pressures and insulated nozzles, to obtain very rapid freezing is known (WO02060411A2). This process does not provide cores suitable for air suspension coating regarding size, shape and mechanical properties and does not disclose the features and compositions of the present invention.

A process for freezing and drying particles by sublimation of water at atmospheric pressure in a fluid bed is known (U.S. Pat. No. 4,608,764). The process does not disclose producing particles or coated microparticles (microcapsules), especially with the compositions of the present invention, for controlled release.

EP1726299 discloses processes for manufacture of cores containing a BAS and microcapsules for controlled release. It discloses solidification by freezing only in connection with undissolved BASS or model substances at high loading using pressurised air for atomisation and drying by vacuum freeze drying and does not specify the yield of cores. Furthermore, it exclusively relates to parenteral controlled release preparations with a high ratio of BAS to core polymer for the most desirable core polymers.

Mixing of powders can be very difficult, especially if they contain sensitive substances, and alternative and simplified processes are needed.

Although many advances in processes for manufacturing of, and preparations suitable for, rapid and controlled-release formulations for biologically active substances, including those for parenteral administration, are known, improvements would be desirable.

### DESCRIPTION OF THE INVENTION

The present invention relates to a process for producing cores, said cores being useful for immediate or rapid release of BASs and as intermediates suitable for manufacturing sustained release preparations, and microcapsules comprising a core and a shell, as well as to the cores and microcapsules as such. The invention further provides for pharmaceutical compositions comprising the cores or microcapsules of the invention. The invention further provides a process for manufacturing two different cores at the same time and a means for mixing cores and particles. In a preferred embodiment the microcapsules are acceptable for parenteral administration.

The invention is based on the finding that, in a process where a discontinuous phase is generated by atomisation and solidified by freezing using a cold medium, a novel and improved process is obtained by the use of a gas which interacts with the discontinuous phase. The invention has been completed based on the use of said discontinuous phase interacting gas (DPIG hereinafter) and involves improved manufacturing processes, and improved products, which realize one or more of the following advantages, alone or in combination with other advantages or features:
possibility of manufacturing cores containing a BAS which are suitable for coating by air suspension technology and useful intermediates in the manufacture of controlled release formulations, or suitable for rapid release applications,
possibility of using a very rapid and gentle process for preparing cores containing a sensitive BAS, also under an inert atmosphere,
possibility of using polymers that are already approved for parenteral use as a matrix for the core, especially with low dose preparation and the use of dissolved BASs,
possibility of manufacturing a preparation comprising at least two cores with different composition simultaneously,
possibility of manufacturing cores and microcapsules faster than with previously available processes, and with fewer process steps,
possibility of using non-mechanical stirring in a proces for manufacturing particles, for example in a cold medium,
a process for mixing frozen discontinuous phases, including cores, and dry cores or powders that provides at least one or several of the following advantages: avoids exposure to heat or high shear forces, avoids problems with static electricity, reduces the need for complex process equipment, increases yield and mixing efficiency, simplifies removal of any liquid medium used, and enables mixing of a powder prior to removal of solvent,
possibility to manufacture cores having a low content of, or being entirely devoid of, organic solvent and/or polyethylene glycol and/or oil,
possibility to reduce the number of transfers between different process equipment and/or environment, and/or to reduce the complexity of the process and equipment,
possibility of avoiding having to reduce the pressure to vacuum in at least one drying step,
possibility of manufacturing cores and/or increasing process efficiency and yield, and/or reducing process time and reducing process cost.

The present invention discloses:
(1) A process for manufacturing or mixing cores or manufacturing a pharmaceutical formulation comprising at least one core, said process comprising contacting a cold medium and at least one DPIG.
(2) The process according to (1), comprises stirring or mixing.
(3) The process according to (1)-(2), wherein said stirring or mixing is by non-mechanical means.
(4) The process according to (1)-(3), wherein at least one DPIG is used.
(5) The process according to (1)-(4), wherein a discontinuous phase is generated by atomisation of a core polymer of the invention, as defined below, or water soluble low molecular weight core substances of the invention, as defined below, and solidified by freezing.
(6) The process according to (1)-(5), wherein at least two discontinuous phases are present in said cold medium, said cold medium preferably being in the form of a liquid.
(7) The process for producing cores according to (1)-(6), wherein an excipient, preferably parenterally acceptable, is dissolved in a solvent.
(8) The process according to (1)-(7), wherein a BAS is present in the discontinuous phase during at least one stage of the process.
(9) The process of (4)-(8) wherein said DPIG undergoes a volume reduction and/or phase transition at any stage of the process, preferably when contacting the cold medium or the walls of of the vessel.
(10) The process of (4)-(9), wherein said DPIG is used in connection with generation of the discontinuous phase by atomisation and/or for improving the interaction of the discontinuous phase with a cold medium and/or separating one part of the discontinuous phase from another part of the discontinuous phase and/or for reducing permanent attachment to the walls of a process vessel.
(11) The process of (1)-(10), further comprising a drying step.
(12) The process according to (11), wherein said cores are further dried by any of the groups of drying methods of the present invention, as defined below.
(13) The process of (11)-(12), wherein the solvent is removed by atmospheric freeze drying, as defined below.
(14) The process of (1)-(13), wherein the process is carried out in a closed vessel, preferably aseptically, and most preferably within an isolator.
(15) The process according to (8)-(14), wherein said BAS is selected from the groups: a) pharmaceutically acceptable drugs, b) parenterally acceptable drugs, c) the specific groups of BASs of the present invention, as defined below or d) the specific drugs of the present invention, as defined below.
(16) The process according to (1)-(15), wherein the discontinuous phase comprises a polymer selected from the groups of water-soluble or water-insoluble core polymers or water-soluble low molecular weight core substances of the present invention.
(17) The process according to (16), wherein said polymer is selected from the specific parenteral or non-parenteral core polymers of the invention.
(18) The process according to (16)-(17), wherein said polymer is a specific water-soluble core polymer of this invention, as defined below.
(19) The process according to (1)-(18), wherein a cold medium selected from a liquefied gas or a cold solvent is used, and optionally removed in the form of a gas.
(20) The process of (1)-(19), wherein the yield of cores is at least 70% or higher.
(21) The process according to (1)-(20), wherein the ratio of BAS to core polymer as defined for the low and high loading compositions of the present invention, respectively, as defined below, optionally in the presence of diluent particles, as defined below.
(22) A process for manufacturing cores in an inert atmosphere, as defined below, optionally also drying said cores in an inert atmosphere, as defined below.
(23) The combined process of (22) and (1)-(21).
(24) The process of (23) wherein the BAS can form degradation products by oxidation and the process is carried out under an inert atmosphere.
(25) A process of preparing a sustained release microcapsule, comprising the application of a release controlling shell onto the core obtained or obtainable according to (8)-(24).
(26) The process according to (25), wherein the shell comprises one or more film-forming and biodegradable and administrable polymers or copolymers.
(27) The process according to (26), wherein the polymer or copolymer is selected from the specific shell polymers as defined below.
(28) The process of any one of (25)-(27), wherein the process for applying the release controlling shell is selected from air suspension coating, spray drying, or an emulsion based process, optionally comprising in-water-drying, with air suspension coating being preferred.
(29) The process of any one of (25)-(28), wherein the release controlling polymer is applied by air suspension coating and the ratio of polymer to core or core polymer is as defined below.
(30) The process of any one of (26)-(29), wherein the composition and the amount of the release controlling polymer is selected so that the duration of release of the BAS is in the range of 3 days to about 6 months, optionally in the absence of any lag-phase and without any explosion of the coating.
(31) The process of (1)-(30), wherein an aqueous solvent is used and said solvent is removed, at least in part, preferably entirely, by sublimation at atmospheric pressure.
(32) A process for producing coated microparticles or microcapsules, wherein at least one solvent used to dissolve at least one polymer is removed at least in part by sublimation at atmospheric pressure at any stage of the process, preferably after preparation of a core or incorporation of a release controlling polymer.
(33) The process according to (31)-(32) wherein said solvent removal is obtained by a flow of gas, optionally without supplying gas to a drying vessel by external means, as defined below.
(34) The process according to (32) or (33) in combination with (1)-(31),
(35) A core obtainable by (1)-(34).
(36) A core obtained by (1)-(34).
(37) A core comprising at least one of the core polymers of this invention, as defined below.
(38) A core comprising at least one of the specific water soluble core polymers of this invention, as defined below, or at least one of the specific water soluble core substances of this invention, as defined below.
(39) The core according to (38) or (39) wherein the content of residual oil is low, as defined below.
(40) The core according to (38) or (39) wherein the content of residual polyethylene glycol is low, as defined below.
(41) The core according to (38) or (39) wherein the content of residual organic solvent is low, as defined below.
(42) The core according to (38) or (39) and (39)-(41).
(43) The core according to (37)-(42) comprising a BAS, wherein the BAS/core polymer ratio is as defined for the low and high loading compositions of the present invention, as defined below.
(44) A composition comprising at least two different populations of cores, as defined below.
(45) The composition according to (44) wherein at least one population comprises cores according to (37)-(43).
(46) A sustained release microcapsule comprising a core according to any one of (37)-(43) and a release-controlling shell of one or more film-forming polymers or copolymers.
(47) The subject-matter according to any one of (8)-(46) where the BAS is not a substance administered with the intention or potential of raising an immune response, as defined below.
(48) The subject-matter according to any one of (8)-(46) wherein the BAS comprises a substance that is administered with the intention or potential of raising an immune response, as defined below.

In one embodiment the process of the present invention for manufacturing cores containing a BAS comprises:
a) providing a liquid core material composition comprising one or more core-forming substances, preferably also a BAS,
b) creating a discontinuous phase of the composition of a) in a continuous phase by atomisation,
c) and solidifying said discontinuous phase by freezing,
d) wherein a DPIG is used in at least one step of the process.

Polymers useable in the present invention, particularly in forming the core or in forming the shell, are all biocompatible polymers, without limitation. They can be selected from those that are or can become acceptable for topical, intraocular, pulmonary or parenteral administration. Preference is given to polymers that are, or can become, approved for parenteral administration. If used for forming a core, they can be dissolved in water or an aqueous medium, or in mixtures of organic solvent and water, and can be solidified to discrete solid units, i.e. cores, by freezing. In a preferred embodiment said cores contain a BAS. In one embodiment said cores can be coated by air suspension technology. These polymers will be referred to as water soluble core polymers in this invention. In another embodiment they can be dissolved in an organic solvent or mixtures of organic solvents, said organic solvent being selected so that it can be removed by cold extraction or preferably by sublimation, and will be referred to as water insoluble core polymers in this invention. If used for forming a shell, they can be dissolved in an organic solvent and can be applied onto the cores to form the shell and are referred to as shell polymers, or coating polymers.

The polymers are biocompatible for their intended application and preferably biodegradable. The polymers are preferably chosen from those that are already being used in parenteral formulations for mammals such as humans. In a preferred embodiment the polymers are chosen from those that are non-immunogenic in humans.

In this invention, all percentages are by weight, unless stated otherwise. In this invention, the content of BAS is expressed as weight percentage and is calculated as the dry weight of the BAS divided by the combined dry weight of the BAS and the polymer (in the following referred to as BAS/core polymer ratio) in the core. The content of BAS in the microcapsules is expressed as the dry weight of the BAS divided by the dry weight of the microcapsules.

In one embodiment of this invention “core” or “cores” are defined as particles suitable for being coated using air suspension technology. In another set of embodiments the expression “core” or “cores” is defined as particles suitable for application to the lungs, the nose, the skin, in wounds or parenterally. In another set of embodiments the term “core” includes any particle or population of particles with a diameter below 500 μm that can be stirred in a cold medium in the presence of at least another particle or particle population. The term “non-mechanically mixable core” includes any particle or population of particles with a diameter below 500 μm that is non-mechanically stirred in a cold medium in the presence of at least another particle or particle population and wherein a mixture of said particles or particle populations is obtained.

In this invention, “diluent particles” is defined as particles with a size below 20 μm in diameter, preferably below 10 μm in diameter, which do not contain any BAS. Said diluents can be selected from particles comprising at least one substance of the following group: monosaccharides, disaccharides, oligosaccharides, polysaccharides, polyamino acid, glycosaminoglycan (mucopolysaccharide), water-soluble synthetic polymers, solid buffer substances, lipids, monoglycerides, diglycerides, triglycerides, phospholipids, and water-insoluble polymers. Said water-insoluble polymers of the diluent particles include all the polymers suitable for forming the core or the release controlling shell.

In one set of embodiments of the present invention “discontinuous phase” is defined to include the droplets, prior to or after freezing, that are to form the cores of the present invention, as well as the cores prior to or after drying. In one set of embodiments the term “discontinuous phase” includes any frozen droplet or dry particle that is present in and interacts with the cold medium.

In this invention the term “discontinuous phase interacting gas” (DPIG for short) is defined as any gas which interacts with the discontinuous phase to improve at least one aspect of a process for preparing cores, said process comprising generation of a discontinuous phase by atomisation and solidification by freezing, compared to said process without the use of a DPIG. In one embodiment said interaction is with the surface of at least a fraction of the discontinuous phase. In one embodiment said interaction is by formation of a structure in which the discontinuous phase is embedded, or a structure or solid which reduces the tendency of at least one part of the discontinuous phase to make contact with another part of the discontinuous phase or with the walls of the process vessel, especially permanently. In one embodiment said interaction is by improving the interaction of the discontinuous phase with a cold medium, for example by increasing the movement of the discontinuous phase in said cold medium. In one embodiment said interaction is by preventing the discontinuous phase to contact at least a part and preferably a major part or all of the walls of a process vessel, by being present on or forming a layer on the wall, said layer comprising said gas in a solid state, prior to the generation of the discontinuous phase. In one embodiment said interaction is by reducing the volume and thus backflow of the DPIG by a phase transfer, for example solidification. In one embodiment the interaction is by a combination of at least two of said interactions. In one embodiment the interaction is by a combination of at least three of said interactions.

The benefits of the DPIG disclosed above are realized in combination with a properly selected cold medium and a sufficiently high concentration of DPIG, said concentration can be determined by simple experiments for each specific combination, and said concentration always exceeding that normally present in air or pressurized air. Said combinations are not limited as long as any of the disclosed benefits of the DPIG is obtained in a process involving manufacturing of cores, preferably containing a BAS, using atomisation and freezing with a cold medium. Combinations include carbon dioxide—liquid nitrogen, carbon dioxide—liquid ethanol, liquid nitrogen—ethanol, carbon dioxide—argon.

The DPIG can be introduced into, or removed from, the process vessel in the form of a gas. At some stage of the process the DPIG can be in the form of a liquefied gas or a solidified gas. In the form of a gas it can be used in connection with generation of the discontinuous phase by atomisation. In the form of a solid it can be present in the continuous phase or cold medium, in which case it can be present either by itself or associated, at least during part of the process, with the discontinuous phase. Said solid can be introduced to the cold medium either in solid form or in the form of a gas that is transformed to a solid in contact with the cold medium. In one preferred embodiment of the present invention the combination of DPIG and the cold medium is selected so that the volume of said gas introduced into the process vessel is reduced by at least 50%, preferably in the range 80-100%, when it comes in contact with the cold medium, or the cold gas overlaying said cold medium. This interaction with the discontinuous phase is based on a change in flow pattern, for example a reduction in the back flow of gas introduced during atomisation and therefore reduced deposition on the walls. In a preferred embodiment said cold medium is present both in the form of a gas and a liquid when the DPIG is introduced into the process vessel. The DPIG is preferably removed in the form of a gas. Examples of DPIGS include carbon dioxide, nitrogen, helium, argon and oxygen. Carbon dioxide and nitrogen are preferred. Carbon dioxide is used in a preferred embodiment. Mixtures of said gases can also be used, for example nitrogen and carbon dioxide, air and carbon dioxide.

In this invention, “non-mechanical stirring” in the cold medium is defined as stirring without the use of mechanical means, for example without paddle or magnetic stirring or mechanically moving the vessel. In the most preferred embodiment said non-mechanical stirring is accomplished by the use of a DPIG. This can provide improved and/simplified stirring compared to that obtained by mechanical means, reduce the complexity of the process and/or equipment design and simplify aseptic manufacturing. Without wishing to be bound by theory it is believed that the very efficient stirring is obtained at least in part by the movement of the DPIG particles, which can be in the size range 3 cm to 5 μm, in the cold medium.

In this invention, “inert atmosphere” is defined as the presence of little or no oxygen. In one embodiment said inert atmosphere refers to the gas and cold medium used for manufacturing the cores. In one embodiment said inert atmosphere further refers to the gas used for drying the cores, as described below. In one embodiment the present invention discloses a process for manufacturing cores in an inert atmosphere. In one embodiment the present invention discloses a process for drying said cores in an inert atmosphere. In one embodiment the present invention discloses a process for preparing cores containing a BAS that can form at least one degradation product by oxidation, wherein said preparation is in an inert atmosphere. For example, some amino acids in peptides and proteins are prone to oxidation. In a preferred embodiment the inert atmosphere is created using any of the DPGIs of this invention and is used both for preparation and drying of the cores.

Any atomizer or spray nozzle capable of generating droplets (discontinuous phase) of the compositions disclosed in this application can be used. The nozzle can be made of metal, for example stainless steel, or a non-metal. In one embodiment the spray nozzle is heated and/or insulated or protected from the cold medium, or from the cold gas overlaying the cold medium, by other means, for example to prevent an undesirable increase in viscosity of the composition or freezing in the nozzle. In one embodiment said generation of droplets is assisted by a gas, for example pressurised air, nitrogen, argon, helium or carbon dioxide. Said gas is preferably supplied at a pressure enabling the creation of a discontinuous phase and its pressure can be used to influence the size distribution of said phase, as is known in the art. In one preferred set of embodiments said spray nozzle is further capable of providing a microclimate gas. The provision of said microclimate gas can be used to create a microclimate for the atomised discontinuous phase wherein factors affecting the generation of solidified cores with, for example a desired size and shape and bioactivity of a BAS, can be controlled better than without provision of said gas. Said factors include gas flow pattern and freezing rate. By providing a heated microclimate gas freezing in the spray nozzle can be avoided and the control of, for example, initial freezing rate of the discontinuous phase can be improved. This enables the use of a lower temperature in the upper part of the vessel. In one embodiment the temperature of said microclimate gas is in the range 10-90° C.

In this invention, “vessel” is defined as a vessel or container bounded by walls in which at least one step of the process is carried out and is contained. Said vessel can optionally have means for mechanical stirring of the cold medium. Said vessel preferably have walls inside said vessel of a material that can be cooled, for example stainless steel, either by contacting a cold medium or gas within the vessel or by contacting the external side of said walls, for example by the use of a double walled vessel or immersion in a cold liquid. It is preferred to cool the walls prior to initiating the process. Although introduction of a cold medium on the walls or within the vessel during atomisation, as is known in the art, can be used it is not preferred. Prior to initiating any steps of the process said walls can be covered with a DPIG, preferably in solid form. In one embodiment said vessel contains only one zone in which freezing and drying is carried out. The vessel contains an inlet to assist atomisation, for example by enabling attachment of a spray nozzle, and can have at least one other inlet for supplying the cold medium; said medium can also be supplied prior to closing the vessel. The vessel can contain at least one outlet for pressure adjustment and optionally one allowing removal of the cold medium. In one embodiment said vessel further contains an additional inlet for supplying a gas, preferably from the bottom. In one preferred embodiment said gas supply allows the cores to be fluidised and dried at atmospheric pressure, preferably by sublimation of the solvent. In one preferred embodiment said vessel also contains means for supplying a shell polymer for coating the dried cores, for example by air suspension coating. Said vessels are known in the art.

In this invention, “core surface substances” is defined as substances that are applied onto the cores prior to application of a release regulating shell. Said substances can be selected from those that can stabilise pH, prevent or reduce aggregation, or improve or control the release kinetics or stability of the BAS. In one set of embodiments of the invention said substances in the form of solid particles are applied, with or without the use of a binder. The amount of functional substance can be in the range of 0.1-30% based on dry weight of the cores and the particle size of the functional substance can be below less than 5 μm or even less than 1 μm.

In this invention, “core polymers” are those dissolved in the composition of step a) of the process. In one aspect of the invention, said polymers are water soluble and referred to herein as “water soluble core polymers”. In one set of embodiments, said polymers can be chosen from the following groups: polyamino acids, polysaccharides, glycosaminoglycans (mucopolysaccharides) and water-soluble synthetic polymers.

In one aspect of the invention, said polymer is not soluble in water, and referred to herein as a “water insoluble core polymer”. In one set of embodiments, said polymers are chosen from the following groups: water insoluble or very slightly water-soluble synthetic or semi-synthetic polymers, as defined in the Handbook of Pharmaceutical Excipients (Third edition, edited by Arthur H. Kibbe, 2000, American Pharmaceutical Association and Pharmaceutical Press).

The “specific water soluble core polymers” of the invention include the following: (1) polyamino acids including recombinant human gelatin, collagen, atelocollagen, protamin, polyarginine and polyornithine; including those with a modified amino acid sequence (2) polysaccharides including amylopectin, sodium carboxymethylcellulose, maltodextrin, alginate, dextran and glycogen; (3) glycosaminoglycans (mucopolysaccharides) including hyaluronic acid, chondroitin sulphate and dermatan sulphate; (4) water soluble synthetic polymers including polyvinylpyrrolidone (PVP) and polyethyleneglycol or polyethylene oxide (both referred to as PEG from hereon). In one embodiment the core polymer has a low amino acid nitrogen content and/or low content of low molecular weight substances. Said core polymer can be used, for example, as a salt or a complex.

The specific “water-insoluble core polymers” include polytartrate, polyanhydrides, polyorthoesters, benzyl esters of hyaluronic acid, polyacetals, poly(ethylene carbonate) copolymers, and copolymers comprising hydroxyl groups and the above-mentioned polymers based on lactic or glycolic acid, for example glucose-PLGA, poly(ether ester) multiblock coplymers, for example based on poly(ethylene glycol) and polybutylene terephthalate), 2,2-bis(2-oxalone) linked poly-lactic or polyglycolic acid. Mixtures of polymers can be used. Said polymers are well known to the person skilled in the art.

The “water soluble low molecular weight core substances” of the present invention are those that can be used to form a core and/or converting a BAS particulate form by immobilisation or encapsulation, either prior to forming the cores or in connection with the formation of the cores. Groups from which the low molecular weight substance can be selected include monosaccharides, disaccharides, oligosaccharides, amino acids and chemically modified amino acids. The “specific water soluble low molecular weight core substances” of this invention include sucrose, mannitol, sorbitol, glucuronic acid, N-acetylglucosamine, succinate, trehalose, glucose, maltose, mannitol, histidine, methionine, cysteine, glutamine, asparagine, tryptophan, lysine, glycine, arginine. Said substances can be used in mixtures and also in connection with a polymer.

Hyaluronic acid is a naturally occurring glycosaminoglycan (mucopolysaccharide) consisting of a linear polymer with repeating units of glucuronic acid and N-acetylglucosamine. Sodium hyaluronate is included in the Pharmacopoeia and is used for ocular, intraarticular and parenteral administration either in chemically un-modified or modified form. In the present invention, hyaluronic acid is defined to comprise all parenterally administrable forms, for example, hyaluronic acid; salts, such as sodium hyaluronate, calcium hyaluronate, zinc hyaluronate; complexes, such as those with benzalkonium chloride and BASs; ionically cross-linked forms, such as those with Fe³⁺; chemically modified forms, such as esters, for example benzyl esters; and forms which have been chemically cross-linked prior to being used in step a) of the process of the present invention, as well as forms suitable for the other administration routes of this invention. The same applies to other parenterally administrable glucosaminoglycans (mucopolysaccharides), for example chondroitin sulphate and dermatan sulphate. The molecular weight for hyaluronic acid is not limited, but can be in the range 50-5000 kDa or 400-4000 kDa.

In one embodiment, only one polymer is used for the manufacture of the cores. In one embodiment said core polymer is selected so that it biodegrades to chemically neutral species and not acidic degradation products. In another embodiment, only one polymer selected from the water soluble core polymers of the invention is used. In one embodiment at least one water soluble low molecular weight core substance of the invention is used.

The polymers are usually dissolved in a solvent according to methods known in the art, for example by heating. The concentration of the polymer, or polymers, is without limitation as long as the cores obtained have the desired content of BAS and a size distribution and mechanical integrity acceptable for air suspension coating or, if used for rapid release, for packaging in dry form or mixing with a vehicle, for example suitable for administering topically and/or in wounds.

Protein stabilisers, buffer substances, surface active substances, substances used to adjust the solubility of the BAS and/or core polymer and substances used to adjust the osmolarity of the solution can be added. When concentrations exceeding 1% and/or a prolonged effect are desired, said substances are preferably used in solid form. Examples include sucrose, gelatin, trehalose, mannitol and solid buffer substances.

In one embodiment, the BAS is in a dissolved form when mixed with the core forming substance, for example polymer, in the composition in step a). In one embodiment, the BAS is in an undissolved form in the composition in step a), preferably as particles with a diameter of less than 20 μm, preferably less than 10 μm, for example in a form that allows retaining its integrity in the process and achieving an acceptable yield, optionally in the presence of a dissolution preventing substance. For the purpose of this invention, the term undissolved form in connection with the BAS means that the BAS in practice can be handled as small particles prior to shaping the composition.

To provide dilution to a desired concentration of BAS and/or polymer in the core, and/or to provide stabilisation of said BAS, diluents or diluent particles may be added to the suspension of BAS or the solution of core forming polymer, or both.

In one set of embodiments low loading cores are provided by adjusting the composition in step a) so that the ratio of BAS to core polymer is in the range 0.0001-10%. In a preferred set of embodiments the BAS is in dissolved form in step a) of the process.

In one set of embodiments high loading cores are provided by adjusting the composition in step a) so that the ratio of BAS to core polymer is higher than 10%. In a preferred set of embodiments the BAG is in undissolved form. Said ratio can be in the range 10-99%, preferably 15-98%.

The mixing of the BAS and the core polymers to provide the composition in step a) can be carried out by conventional methods. The BAS may be added to the polymer solution, or vice versa. The temperature is selected based on the solubility properties of the polymer solution and the temperature sensitivity of the BAS. The temperature is below 60° C. in one set of embodiments, optionally below 50° C. Lower temperatures may be preferable to support retaining integrity of the BAS.

The BAS is selected from those that can be administered to elicit a beneficial or therapeutic effect. In one embodiment said BAS can be administered parenterally. In one embodiment said BAS can be administered pulmonary, nasally or in a joint. In one embodiment said BAS can be administered topically, for example to a wound. In one preferred embodiment, substances are excluded that are administered with the intention or potential of raising an immune response, for example antigens, vaccines or viruses, said excluded substances being defined herein as immunologically active substances (abbreviated as IAS).

The BAS may be selected from protein drugs, or non-protein drugs. Protein drugs, which include peptides, can be selected from the following specific subclasses: glycosylated proteins, non-glycosylated proteins, recombinant proteins, chemically modified proteins, growth factors, cytokines, blood coagulation factors, peptides, T-cell immunity regulating enzymes, immunosuppressants, peptide analogues, somatostatin analogues, monoclonal antibodies and modified monoclonal antibodies.

Specific examples of protein BASs in this invention are human growth hormone, erythropoietin, interferon (for example type alpha, beta or gamma), Factor VII, Factor VIII, LHRH-analogues, glucagon-like peptides (GLP), insulin like growth factor I, C-peptide, bone morphogenetic protein, cyclosporin A, octreotide, follicle stimulating hormone, epidermal growth factor, insulin, liraglutide, interleukin 1ra, macrophage colony stimulating factor, granulocyte macrophage colony stimulating factor, indoleamine 2,3-dioxygenase, granulocyte colony stimulating factor, triptorelin, and interleukin. Particularly preferred protein BASS for use in the present invention are human growth hormone, erythropoietin, interferon alpha, interferon alpha8, interferon beta, interferon gamma, cyclosporin A and glucagon-like peptides. Analogues or fragments of the above substances and macromolecules with similar therapeutic function are also included in the invention.

In one embodiment, the non-protein BASS may be selected from those with a low molecular weight, defined in this invention as generally below 3.5 kDa, preferably below 1 kDa. In one embodiment, said non-protein BASs may be selected from antitumour agents, antibiotics, anti-inflammatory agents, antihistamines, anti-alcohol dependence substances, sedatives, muscle-relaxants, antiepileptic agents, antidepressants, antiallergic agents, bronchodilators, cardiotonic agents, antiarrhythmic agents, vasodilators, antidiabetics, anticoagulants, haemostatic agents, neuroprotective agents, narcotics and steroids. Specific examples include risperidone, naltrexone, morphine, bupivacaine, loperamide, indoleamine 2,3-dioxygenase inhibitors, heparin, low molecular weight heparin with or devoid of anticoagulant activity, low molecular weight hyaluronic acid, or derivatives of any these.

The composition provided in step a) is shaped by creating a discontinuous phase in a continuous phase, preferably by atomisation. In the most preferred embodiment said shaping is by atomisation and the discontinuous phase is solidified by freezing. In one embodiment particles suitable for coating using air suspension technology, for example in terms of size distribution, can be obtained. In one embodiment said shaping is carried out in the absence of any compounds that cannot be administered parenterally and cannot be removed in subsequent process steps. In one embodiment especially useful for substances that are easily degraded, for example by oxidation, an inert atmosphere is used in the process vessel during said shaping and solidification. In one embodiment the size of the discontinuous phase, for example the droplets, is preferably selected so that the cores obtained have a size such that 80% of the material is in the range of 10-200 μm, preferably 20-180 μm in dry state. In one embodiment particles suitable for pulmonary administration are obtained.

In one embodiment particles suitable for nasal application are obtained. In one embodiment particles suitable for topical administration are obtained.

The continuous phase can be a liquid or gas that has a temperature below the freezing point of the discontinuous phase at least in part of said phase. In the most preferred embodiment the continuous phase is a gas. The temperature of the continuous phase can be in the range of from −196° C. to +40° C. The optimal temperature to obtain freezing of the discontinuous phase in the continuous phase can be determined by simple experimentation. Freezing should be rapid but not so rapid that it occurs before the desired shape of the cores have been obtained In one preferred embodiment the temperature of the gas in the proximity of the device used for creating the discontinuous phase is higher than in at least one other part of the vessel. In one embodiment there is a temperature gradient in the continuous phase, with the lowest temperature in proximity of the cold medium. The temperature in the upper part of the vessel or in the proximity of the nozzle can be in the range 4-40° C. to −130° C. In one embodiment the temperature in said upper part is −5° C. to −80° C. A person skilled in the art will understand that several of these temperatures can vary during the process, especially for large scale manufacture.

The required shape of the discontinuous phase when frozen depends on the intended application. For some applications the shape is not limited. When used as an intermediate for manufacturing controlled release microcapsules by air suspension coating a spherical shape is preferred, although other shapes are acceptable as long as the application of the coating can be carried out acceptably. Suitable combinations of the pressure of the atomisation gas, the temperature and optionally temperature gradient of the continuous phase and the pressure and temperature of any microclimate gas can be determined by simple experimentation.

After the solidification the solvent provided in step a) is removed. In one embodiment said removal is by sublimation. In one embodiment said removal is by cold extraction. In one embodiment the cores are dried during said removal. In one embodiment the cores are dried after said removal. Preferably, the drying method is selected such that the integrity of the BAS is retained sufficiently, adequate drying is obtained and the integrity of the cores is retained. Examples of groups of drying methods are air-drying, vacuum drying, vacuum freeze-drying, drying using a fluidised bed or air suspension equipment or the like, or atmospheric freeze drying. In a preferred embodiment drying is carried out at a temperature at which the cores remain frozen. In one embodiment the temperature is in the range −5 to −100° C. below the melting point of the cores. In one embodiment the drying is carried out by sublimation. In one embodiment said sublimation is at about atmospheric pressure. In one preferred embodiment drying is by atmospheric freeze drying in a fluid bed, air suspension coating equipment or similar. In the most preferred embodiment drying is by sublimation of water at about atmospheric pressure in fluid bed, air suspension coating equipment or the like. The diameter of the cores is preferably determined after the drying step.

In one set of embodiments the atmosphere in the drying step is selected to be an inert atmosphere. When said drying comprises a flow of gas, said dry gas can be supplied by means known in the art, for example, from a pressurised vessel. In one embodiment the inert gas is supplied as a liquefied gas or a solid, and allowed to form a dry gas. In one embodiment the cold medium comprises a liquefied gas in which the solvent in the cores freeze, after which the frozen cores are deposited on a filter and the cold medium below said filter, and then the cores are dried by allowing the cold medium to create a flow a dry gas, that can be used as described above.

The composition of the composition in step a), in combination with the solidification and drying conditions are chosen to provide dry cores which in practice can be handled as a free flowing powder, optionally after mechanical treatment or sieving.

In the present invention the DPIG is not used in the form of a supercritical fluid. In one embodiment of the present invention, the pressure is lower than that at which carbon dioxide forms a supercritical fluid at 40° C. in all process steps. In one embodiment the pressure is higher than that needed for vacuum freeze drying. In one embodiment the pressure is lower than that at which carbon dioxide forms a supercritical fluid at 40° C. and higher than that needed for vacuum freeze drying in all process steps. When referring to pressure in the present invention it is meant the pressure to which the composition, cores and microcapsules are exposed and the pressure of the gas used for atomisation in step b) is expressly excluded. In one embodiment the pressure does not exceed 10 bar when the discontinuous phase is generated. In one embodiment said pressure is in the range 0.5-5 bar. In one embodiment the pressure when the polymer solvent is removed is not lower than 0.8 bar. In a preferred embodiment the pressure is atmospheric pressure during said solvent removal. In the most preferred embodiment the pressure is higher than 0.9 and lower than 1.1 bar in all process steps.

The integrity of the BAS after encapsulation in the cores of the invention can be determined with methods known in this art. When this determination is carried out in vivo, the cores or microcapsules are administered parenterally, possibly in dissolved form, and the effect is compared with the one obtained with the same amount of the HAS in a suitable form, for example in solution. When it is required that the biologically active substance is in dissolved form, for example in some in vitro assays, the substance can be allowed to diffuse out of the core in an aqueous medium or the cores can be dissolved. The preferred methods are changing the solvent, the pH, heating or enzymatic treatment, or combinations thereof.

One embodiment of the present invention provides a process for manufacturing two populations of cores simultaneously or within one batch. In one embodiment said manufacture is carried out by introducing at least two populations of discontinuous phases into the same process vessel, either at the same time or one after the other. As described above atomisation is preferred for generating the discontinuous phase in the presence of a solvent and freezing is preferred for solidifying. In this embodiment stirring is created in the cold medium. The means of creating stirring is not limited. In a preferred embodiment said stirring is by non-mechanical means. In the most preferred embodiment said stirring is obtained by the use of a DPIG. At least one, preferably two to five, of the core populations can have a composition as defined for the cores above.

Another embodiment of the present invention provides a simplified means for mixing cores or other particles by interaction with a discontinuous phase in a cold medium. Mixing is obtained by introducing at least two populations of said cores, particles, or mixtures thereof, into a cold medium and creating stirring. Said cores can contain a solvent, for example as described for the process above, in which case the process includes a drying step, as described above. At least one population of cores or particles can be introduced in dry form. The required mixing may depend on the intended application and can be determined by simple experiments. The means for creating mixing in the cold medium is selected from mechanical and non-mechanical means. In a preferred embodiment non-mechanical means are used to simplify process design and equipment and avoid losses by attachment to a stirrer. Said non-mechanical means can be selected from introduction of heat, preferably by application to the exterior of the process vessel, and the use of a DPIG. Said cold medium and said DPIG are preferably removed in the form of gas. There is no upper limitation to the number of cores that can be mixed with this process.

In one preferred embodiment, the process further comprises a step of applying a release controlling shell onto the cores, said cores being intermediates for preparing a sustained release formulation. Said application can be carried out by emulsion or spraying based processes. In the emulsion based processes, it is preferred to use the preformed cores, as defined above, in dry form. The cores are suspended in a solution of the release regulating polymer, or polymers, dissolved in at least one organic solvent. Water or buffer can be added in an amount sufficient to wet but not to dissolve the cores to, for example, improve precipitation of the release regulating polymer onto the cores. Deposition of said polymer onto the cores can be obtained by interfacial precipitation, addition of anti-solvent, or removal or organic solvent by extraction or evaporation, optionally after freezing, or the like. Removal of organic solvent by in-water-drying is preferred for emulsion based processes. Said processes are well known in this technology area and need not be described further. Air suspension coating provides essentially or exclusively single core microcapsules, whereas the emulsion and spraying based processes tend to provide multicore microcapsules.

The preferred method for application of the release regulating polymer(s) is air suspension coating according to WO 97/14408, incorporated herein by reference, and details in this regard can be obtained from this publication. This method can provide a very rapid evaporation of the organic solvent in which the polymers are dissolved and also allows the use of non-toxic solvents.

The release-controlling polymer can be, without limitation, any polymer that is parenterally administrable and can form a release controlling shell on the cores disclosed in this invention, herein referred to as “shell polymer”. It is preferred that the polymer is biodegradable. Specific shell polymers are, for example, polymers or copolymers prepared from alpha-hydroxy acids, preferably lactic acid and/or glycolic acid, or from cyclic dimers selected from glycolides and lactides, for example PLA, PLGA, polytartrate, polyanhydrides, polyorthoesters, polyacetals, poly(ethylene carbonate) copolymers, and copolymers comprising hydroxyl groups and the above-mentioned polymers based on lactic or glycolic acid, for example glucose-PLGA, poly(ether ester) multiblock copolymers, for example based on ply(ethylene glycol) and poly(butylene terephthalate), 2,2-bis(2-oxalonie) linked poly-lactic or polyglycolic acid. Mixtures of the polymers can be used. PLGA is preferred. In one embodiment, the release-controlling polymer is not the same polymer that is used to form the core.

The amount and composition of the release regulating polymer that is applied is determined by the desired release characteristics, and depends on several factors, for example the size distribution of the cores, the therapeutic and toxic serum concentrations of the BAS and the desired duration of the release and therapeutic effect. This can be determined by the person skilled in the art by determining the release kinetics in vitro, or preferably in vivo, as a function of the amount of the release regulating shell. It is preferable to obtain an acceptably low burst. Generally, the properties of the release regulating shell is selected so that the release of the BAS starts soon after administration to man to avoid a prolonged lag-phase while still having an acceptably low burst, and to provide a continuous, or essentially continuous, release thereafter. The properties of the shell is also selected so that the release of the BAS is prolonged compared to the release from the cores without said shell, and the duration of release can be for at least 1 day, 3 days, one week, two weeks, about one month or longer. This generally requires about 0.3 to 10, or 0.4 to 6, or 0.5 to 2, or about 0.6 to 1.1 gram of polymer(s) per gram of cores when the core diameter is between 40 to 120 μm.

The release regulating shell (coating) can comprise several different polymers with similar or different chemical composition, in either uncomplexed or complexed form, as well as additives that are applied either in soluble or solid form, for example buffer substances, surface active agents, salts and other ionic compounds. The optimum composition of the shell can be determined by simple experiments, like factorial designs and response surface optimisation, by determining the release kinetics in animal experiments, for example in the rat, pig or monkey. In those cases where antibodies generated against the encapsulated protein affects the evaluation, immunosuppression by methods known in the art can be used or appropriate transgenic animals selected.

Prior to the application of the release-controlling shell, one or several functional substances may be applied onto the cores, referred to herein as “core surface substances”. It is preferred that the substances are applied by spraying in an air suspension coating machine. The substance can be dispersed in a solution of the same polymer or a different polymer or a mixture thereof as compared to the one that constitutes the core matrix. Core surface substances useful with the invention can be selected from those that can stabilise pH, improve or control the release kinetics or stability of the BAS. Buffer substances are used in one set of embodiments.

Another embodiment of the present invention is directed to a process for manufacturing cores and microcapsules aseptically. Many of the BASS of the present invention cannot withstand sterilisation by heating or radiation and therefore the compositions of the present invention in those cases need to be manufactured aseptically to be acceptable for parenteral administration. In one embodiment said manufacture is carried out in a clean room or an isolator placed in a clean room. The use of isolator technology for aseptic manufacturing is known in the art. In one embodiment said process is carried out in an isolator without reducing the pressure to vacuum in any process step. In a preferred embodiment all the steps of the process are carried out to completion in an isolator without transferring any intermediate outside said isolator, said completion being to cores for rapid release or microcapsules for controlled release. This provides increased sterility assurance and a more efficient process. All the components of the composition or formulation and all media are introduced into the isolator in sterile form. The method used for sterilisation is chosen from those acceptable in the art, for example by the regulatory authorities, and providing acceptable stability of the substance, for example heating, gamma or beta radiation, or sterile filtration. In one embodiment solidification and drying are carried out in one single zone or vessel.

Another embodiment of the present invention is directed to the cores and microcapsules obtainable using the processes described above. In one embodiment a core comprises at least one polymer selected from the groups or specific polymers listed above in connection with the process. In one embodiment a core comprises at least one of the specific water soluble low molecular weight core substances listed above. In one set of embodiments, the core matrix consists of one polymer.

In one embodiment the cores or particles have a low content of residual substances. In one embodiment the content of PEG is less than 0.1%, preferably below 0.02%. In one embodiment the content of oil is less than 0.1%, preferably below 0.02%. In one embodiment the content of organic solvents is less than 0.1%, preferably below 0.02%. In one preferred embodiment the cores or particles have a a low content, as defined above, of oil, organic solvent and optionally PEG.

The core matrix may be selected to be one that is not chemically cross-linked. The core can be essentially homogeneous and not hollow. The size of the core is characterised by the diameter, which is determined in the dry state by, for example, light or electron microscopy. For irregularly shaped particles, the longest distance is measured and agglomerates are treated as a single entity. The average diameter when intended for air suspension coating is in the range 10-250 μm, or 15-200 μm, or 20-120 μm, or even 30-100 μm. For topical administration the average diameter may be up to 1000 μm, for nasal up to 70 μm, and for pulmonary administration up to 10 μm, preferably up to 5 μm.

The core preferably contains at least one BAS. It may contain two BASs without any limitation, for example C-peptide and insulin, an interferon and a colony-stimulating factor, for example granulocyte-macrophage colony stimulating factor and interferon gamma, an antiviral agent and interferon, or one, two or more vaccine components and an adjuvant.

In one embodiment the cores comprise less than 5% of the core polymer (polymeric binder). In one embodiment it is lower is less than 4%, preferably less than 3%. In one embodiment the concentration of core polymer, preferably sodium hyaluronate, is about 2.5% or lower. Diluent particles can be used as appropriate to obtain the desired BAS and/or dry content. Said diluent particles are only included in dry weight if comprising a polymer and/or a BAS.

In one set of embodiments the core can provide rapid release of the BAS. In the present invention “rapid release” of a BAS is defined as a release of at least 60 percent within 1 day after administration in vivo or under suitable conditions in vitro. When the desired duration of release is longer than that obtained from the cores, and said cores can be used to manufacture a sustained release formulation with the desired duration, the cores may be defined in this invention as intermediates for producing a sustained release formulation. The in vitro release is determined at 37°. In many cases the cores can simply be dissolved in an aqueous solution or allowed to release the BAS in undissolved state. Enzymes can be used to dissolve the cores when appropriate, especially to simulate the in vivo environment.

The cores can optionally have one or several functional substances applied to their surfaces, in one embodiment not dispersed in a polymer, as described above for the process from which additional details can be obtained.

The microcapsules of the invention comprise a core containing a BAS and a polymer, as well as a release controlling shell, as defined above. The core and the shell can be distinguished from each other by electron microscopy. The polymers in the core and in the shell can have either different or similar properties. Different properties is preferred and most preferably they comprise chemically distinct polymers. The release controlling shell does not contain any BAS in one set of embodiments, for example less than 2% compared to the core, or less than 0.2% or less than 0.01%. In one set of embodiments at least 50%, or at least 80%, or at least 90% or even at least 98% of the microcapsules have one single distinct core.

In another set of embodiments, the microcapsules are further characterised by having an aggregation preventing substance applied to their surfaces.

In one embodiment, the bioactivity of the BAS is essentially retained, for example at least 70%, or at least 80%, or at least 90% or even at least 97%, as compared to the bioactivity of the BAS before encapsulation. For example, for human growth hormone or erythropoietin there is no increase, or an acceptable increase, in the content of dimer or polymer during encapsulation in the core.

In another set of embodiments, the microcapsules contain at least 15% BAS and display an initial release, defined as the area under the concentration-time curve, in the first 24 hours after administration of not more than 20%, preferably not more than 15% and most preferably not more than 10% in excess of the desired release. In another set of embodiments, the microcapsules contain at least 20% BAS and have an initial release of less than 20% for a preparation that provides detectable serum levels of the BAS for one week and less than 10% for a preparation providing detectable serum levels for about two to four weeks. In these embodiments, it is preferable to have a duration of the release of the BAS of at least 1 day, at least 3 days, at least one week, at least two weeks, at least about one month or even longer. These embodiments have been shown to be advantageous when used in combination with protein or peptide BASs, specifically human growth hormone, erythropoietin, interferons and glucagon-like peptides.

Another embodiment of the present invention is a pharmaceutical composition containing at least two different populations of cores either in uncoated or coated form. The difference may comprise, for example, different core polymers, different BASs, the lack of BAS in one population and different size distributions.

The microcapsules can be stored dry, for example at a temperature in the range of 2 to 25° C., for example via refrigeration. They can be administered in dry form or suspended in a suitable liquid prior to administration, for example using a fine needle, with a size 21 G or smaller, preferably 23 G or smaller, and most preferably 25 G or smaller, or as a dry powder. Said administration can be, for example, intralipomatous, intramuscular, subcutaneous, or local, for example in a joint, the brain or a specific organ.

### EXAMPLES

### Reference Example 1

A composition of starch granules (model substance for an undissolved BAS, 33% W/W of the composition) suspended in an aqueous solution of sodium hyaluronate (1%, 67% W/W of the composition) was sprayed into a stainless steel vessel (diameter 45 cm, height 67 cm) containing liquid nitrogen, using pressurised air (2.5 bar) using a spray nozzle from a Huttlin Kugelcoater (stainless steel). The liquid nitrogen remained clear apart from some white material identified as frozen cores of the composition. There seemed to be substantial backflow of gas and many cores were attached to the walls of the vessel.

Example 1

When the experiment in Reference Example 1 was repeated with carbon dioxide as the gas for atomisation there was much less material on the walls of the vessel and a white substance was formed in the liquid nitrogen. Substantial stirring was observed in the liquid nitrogen. In the light microscope the substance was seen to be present between the cores, which were also surrounded by or embedded in the substance. When the process vessel was heated by immersing it in hot water the liquid nitrogen evaporated and a white solid was left in the vessel. This solid disappeared at room temperature without melting into a liquid.

This experiment demonstrated that when a DPIG was used for atomisation it solidified in the cold medium and provided an improved process compared to when air was used for atomisation. Improvements observed were increased stirring of the liquid nitrogen, a reduction in the number of cores attached to the walls of the vessel, and separation of the individual frozen cores from each other and thus reduced agglomeration. In addition the use of a gas the volume of which was reduced in the process, in this case by a phase transfer from a gas to a solid, reduced the flow of said gas back into the process vessel.

### Example 2

Two identical (8×12×4 cm) stainless steel vessels were dried at 60° C. One was cooled by immersion in liquid nitrogen and then its walls were covered with solid carbon dioxide by spraying carbon dioxide gas onto the cold walls. Both were placed at the bottom of a larger stainless steel vessel (45 cm diameter, 67 cm high) and about 70 ml of liquid nitrogen was poured into each and then a composition according to Example 1 was sprayed using pressurised air delivered from a Huttlin Kugelcoater (2 bar) whereafter the vessels were placed on a bench for observation. A white powder (frozen cores) was observed on the walls of the control vessel, where it remained until it melted when the liquid nitrogen had evaporated and condensation formed on the cold walls. The material deposited on the vessel pre-coated with carbon dioxide was removed from the wall when the dry ice fell off and the lower parts of the vessel, which had remained cold during the evaporation of the liquid nitrogen, did not contain any visible material. This experiment demonstrates that sticking of the cores to the wall can be reduced and even entirely avoided despite using air for atomising the composition by a solidified DPIG on the walls of a stainless steel vessel and that keeping the wall cold is beneficial.

### Example 3

Cores were prepared essentially according to Reference Example 1 or Example 1, respectively, using either pressurised air or carbon dioxide for atomisation. The cores were freeze dried at atmospheric pressure in the bottom part of a Huttlin Kugelcoater covered with a steel sieve (40 μm), referred to as the drying vessel. Dried and cooled air (copper tube immersed in ethanol and dry ice) supplied to the spray nozzle and the air distribution plate providing a starting temperature around −20° C. for the drying. The cores were poured into the drying vessel suspended in liquid nitrogen with the air supply on to prevent flow below the air distribution plate. For the preparation made using carbon dioxide for atomisation the drying vessel was pre-cooled by addition of solid carbon dioxide and liquid nitrogen. When the drying seemed completed (within two hours) the air supplied was heated to avoid condensation and fluidisation continued until at least room temperature was reached.

Many dried and free flowing cores could be recovered from the preparation made using air for atomisation but a large flake remained attached to the air distribution plate throughout the process. When carbon dioxide had been used for atomisation no such flakes could be observed in the drying vessel or in the preparation. This demonstrates that when a DPIG was used for preparing the cores according to Example 1 this provided a preparation of cores with improved properties for freeze drying at atmospheric pressure by fluidisation in a flow of cold gas, compared to when air was used for preparation of the cores as in the prior art processes (Reference Example 1).

### Example 4

Cores were prepared according to Example 1 with spraying into the vessel where the gas phase had a temperature of about −126° C. or −54° C. and where stirring was obtained in the liquid nitrogen by a solidified DPIG by spraying carbon dioxide prior to spraying the core forming compositions. The lyophilized preparation consisted of threads which were not free flowing for the −126° C. preparation, indicating freezing prior to proper droplet formation, and free flowing cores suitable for air suspension coating and injection through a needle, although some hade solidified prior having reached spherical shape, for the −54° C. preparation. This demonstrates that cores suitable for air suspension coating can be prepared by properly combining the temperature of the gas to the composition, manufacturing conditions and equipment.

### Example 5

A temperature gradient suitable for preparing cores was established in stainless steel vessel (diameter 45 cm, height 67 cm), with a lid and containing about 1 L of liquid nitrogen. Just above the liquid nitrogen the temperature was roughly in the range −125-−133° C., half way up −50-−55° C. and −30-−35° C. at the top where the spray nozzle is placed. Cores were prepared essentially according to Example 1 when the liquid nitrogen hade evaporated and the temperature in the bottom of the vessel was about −60° C. and −8° C. at the top. This experiment demonstrated that cores can be prepared by atomisation/freezing at a temperature around −10° C. at the top of the vessel and that suitable temperature gradients can be formed.

### Example 6

Two populations of cores were prepared at the same time essentially according to example 1 but without precooling of the vessel walls and without a lid. The compositions—one containing hGH and one containing BSA—were sprayed at the same time into the vessel using two spray nozzles and carbon dioxide for atomisation. After evaporation of the liquid nitrogen the preparation was vacuum freeze dried to provide free flowing cores. Four samples of about 3 mg each were taken, dissolved and analysed by GPC-GPLC. The homogeneity of the content of the proteins in the cores, expressed as the standard deviation, of the area under the curve was 7.4% and 15.9% for BSA and hGH, respectively. This demonstrates that two populations of cores can be prepared simultaneously in the same vessel by the use of a DPIG; and also that non-mechanical stirring of cores in a cold medium can provide adequate mixing for many applications.

### Example 7

Solid carbon dioxide was applied on the interior walls of a stainless steel vessel (8×12×4 cm) essentially according to example 2 by placing it in a somewhat larger vessel containing liquid nitrogen and supplying carbon dioxide gas to obtain a solidified DPIG in the cold medium in order to create stirring. Then about 1 g of dry starch microspheres containing magnetite and therefore appearing black (sieved 100-160 μm) was added onto the liquid nitrogen, followed by about 0.15 g of dry cores appearing white (containing rice starch and sodium hyaluronate as binder; sieved 125-160 μm). When the liquid nitrogen in the larger vessel had evaporated heated air was supplied to the outside of the vessel to increase the non-mechanical mixing. Visual observation when the cold medium had evaporated showed that the two populations had been mixed and this was confirmed by observations in the light microscope. This demonstrates that mixing of two populations of dry particles can be obtained by only non-mechanical means using a DPIG in a cold medium and that the obtained mixture can be recovered simply in dry form by allowing the cold medium and the DPIG to evaporate.

### Example 8

A small stainless steel vessel (24 cm diameter, height 25 cm) was cooled by placing it in liquid nitrogen and used to manufacture cores (with a BAS/core polymer ratio of about 98%) containing cyclosporin A (USP) with sodium hyaluronate (1%) and to demonstrate the effect of heating the microclimate gas. The spray nozzle was of stainless steel and normally used in an air suspension coater (Kugelcoater, Huttlin). The nozzle was supplied with atomisation gas (carbon dioxide, 2 bar) and microclimate gas (carbon dioxide, heated to 47° C.). The vessel was covered with a lid, trough which the nozzle was brought just under the lid and the composition sprayed. The temperature just under the lid was −96° C. after spraying. The liquid nitrogen was allowed to evaporate and then the preparation was freeze dried under vacuum. The yield was 65% and the preparation contained many discrete spherical cores. The use of heating the microclimate DPIG provided an improvement of the process and enabled the manufacture of discrete spherical cores even in this too small vessel in combination with a very low temperature in the continuous phase gas and also prevented any tendency of the composition to freeze in the spray nozzle.

### Example 9

Cores were manufactured essentially according to Example 1 using pressurised air (2 bar) for atomisation but with a cold medium comprising ethanol to which liquid nitrogen was added as the DPIG to obtain non-mechanical stirring. The amount of liquid nitrogen was sufficient to obtain substantial stirring on the surface of the cold medium but not enough to solidify the cold medium. Cores suitable for air suspension coating were obtained.

### Example 10

Cores suitable for air suspension coating and containing either human growth hormone (hGH) or erythropoietin (EPO) were prepared by essentially according to Example 1 using carbon dioxide for atomisation but with ethanol or ethanol containing solid carbon dioxide as the cold medium. For hGH the composition contained sodium hyaluronate (1%, about 4.1 g), diluent particles (rice starch, Sigma 57260, 1.83 g) and hGH (217 mg) and for EPO sodium hyaluronate (about 3.4), diluent particles (about 1.48 g) and EPO (11 mg). There was substantial stirring in the cold medium in the presence of solid carbon dioxide and little, if any, backflow of gas. The cold medium was removed by filtration and the cores dried using air at room temperature and atmospheric pressure. Cores suitable for air suspension coating were formed containing hGH (624 mg) and EPO (468 mg). No degradation products of hGH or EPO were detected by electrophoresis (SDS-PAGE 12 and 18%) with silver staining. No increase in the content of dimer or polymer forms of hGH were observed by HPLC size exclusion chromatography (SEC-HPLC, TSK2000 SWx1, Tosoh Corporation) according to Reslow et al (Sustained release of human growth hormone (hGH) from PLG-coated starch microspheres. Drug Delivery Systems and Sciences, 2002, 2,1 103-109). The importance of the temperature of the cold medium for the stability of the protein was seen for EPO, where a slight increase in dimer content was observed with Western blotting when carbon dioxide was present in the cold medium and a clearly higher increase in the absence of carbon dioxide in the cold medium.

### Example 11

Microcapsules were prepared by applying a release controlling shell onto cores comprising cyclosporin A, prepared essentially according to Example 8, by air suspension technology according to WO9714408.

1-20. (canceled)

21. A process for preparing a pharmaceutical formulation comprising a core, said process comprising contacting a cold medium and at least one discontinuous phase and at least one discontinuous phase interacting gas, while said cold medium is stirred non-mechanically.

22. A process according to claim 21, wherein a discontinuous phase is generated by atomization and solidified by freezing, and preferably wherein said discontinuous phase interacting gas is used in connection with generation of the discontinuous phase and/or for improving the interaction of the discontinuous phase with a cold medium and/or for reducing attachment of said discontinuous phase with the process vessel

23. The process according to claim 21, wherein said cold medium is selected from a liquefied gas or a cold solvent, preferably a liquefied gas, and optionally wherein the combination of discontinuous phase interacting gas and the cold medium is selected so that the volume of said gas introduced into the process vessel is reduced by at least 50%, preferably in the range 80-100%, when it comes in contact with the cold medium, or the cold gas overlaying said cold medium.

24. The process according to claim 21, wherein at least one biologically active substance is present in the discontinuous phase, and preferably wherein the process is carried out in an inert atmosphere

25. The process according to claim 21, wherein said discontinuous phase is generated and solidified in a closed vessel, and at least a part of said vessel being in contact with a gas or liquid having a temperature of −10° C. or lower prior to initiation of the atomization, and optionally wherein said vessel comprises one single zone for solidification and solvent removal.

27. The process according to claim 21, wherein the temperature of the gas phase at the top of the vessel is in the range −130° C. to +40° C. and the temperature of the gas phase is lower in at least one other part within the vessel.

28. The process according to claim 21, wherein said cores are further dried, said drying method being selected from the groups: vacuum freeze drying, atmospheric freeze drying or cold extraction, optionally wherein said drying is carried out in the same vessel in which said dispersion and solidification are carried out.

29. The process according to claim 21, wherein the discontinuous phase comprises a polymer selected from collagen, atelocollagen, protamin, polyarginine, polyornithine, recombinant human gelatin, alginate, amylopectin, sodium carboxymethylcellulose, maltodextrin, dextran, glycogen, hyaluronic acid, chondroitin sulphate, dermatan sulfate, polyvinylpyrrolidone, polyethylene glycol or polyethylene oxide or a low molecular weigh core foaming substance selected from sucrose, mannitol, sorbitol, glucuronic acid, N-acetylglucosamine, succinate, trehalose, glucose, maltose, mannitol, histidine, methionine, cysteine, glutamine, asparagine, tryptophan, lysine, glycine, arginine.

30. The process according to claim 21, wherein at least two discontinuous phases are contacted with the cold medium.

32. The process according to claim 21, wherein a microclimate gas is provided in connection with generation of the discontinuous phase, optionally wherein said microclimate gas has a temperature in the range 20-90° C.

33. The process according to claim 21, wherein all process steps are carried out aseptically within an isolator without transfer of any intermediate outside said isolator

34. The process according to claim 21, wherein the cold medium is a liquefied gas, and wherein the discontinuous phase interacting gas is selected from carbon dioxide, nitrogen, helium, argon and mixtures thereof.

35. A process for preparing a sustained release microcapsule, comprising the step of applying a release-controlling shell onto a core prepared according to claim 21, preferably by air suspension coating, and even more preferably in an inert atmosphere.

36. A process for preparing a pharmaceutical formulation comprising a core, said process comprising contacting a cold medium and at least one discontinuous phase and at least one discontinuous phase interacting gas, said process comprising generation of a discontinuous phase by atomization and solidification by freezing and wherein said discontinuous phase interacting gas is selected to provide an interaction with the discontinuous phase, said interaction being selected from:
a) formation of a structure in which the discontinuous phase is embedded; or
b) formation of a structure or solid which reduces the tendency of at least one part of the discontinuous phase to make contact with another part of the discontinuous phase or with the walls of the process vessel, especially permanently; or
c) increasing the movement of the discontinuous phase in said cold medium; or
d) reducing the volume of the discontinuous phase interaction gas by a phase transfer, preferably by solidification.

37. The process according to claim 36 wherein the discontinuous phase interacting gas provides at least two, preferably at least three of said interactions.

38. The process according to claim 36, wherein the cold medium is a liquefied gas, and wherein the discontinuous phase interacting gas is selected from carbon dioxide, nitrogen, helium, argon and mixtures thereof, and preferably wherein the combination of discontinuous phase interacting gas and the cold medium is selected so that the volume of said gas introduced into the process vessel is reduced by at least 50%, preferably in the range 80-100%, when it comes in contact with the cold medium, or the cold gas overlaying said cold medium.

39. The process of claim 36, wherein the frozen core is dried and a release controlling shell is applied onto the dried core, preferably by air suspension coating and even more preferably by air suspension coating in an inert atmosphere.

40. A process for manufacturing cores containing a biologically active substance comprising:
a) providing a liquid core material composition comprising one or more core-forming substances chosen from the following groups: polyamino acids, polysaccharides, glycosaminoglycans (mucopolysaccharides) and water-soluble synthetic polymers, preferably also a biologically active substance,
b) creating a discontinuous phase of the composition of a) in a continuous phase by atomization, and solidifying said discontinuous phase by freezing, preferably by contacting a liquefied gas or a gas overlaying a liquefied gas, or a combination thereof, and wherein a discontinuous phase interacting gas selected from carbon dioxide, nitrogen, helium, argon and mixtures thereof is used in at least one step of the process and optionally wherein the stirring in said liquefied gas is non-mechanical.
